(19) United States
(12) Patent Application Publication
(10) Pub. No.: US 2002/0043550 A1
(43) Pub. Date: Apr. 18, 2002

(54) Wire bonding apparatus and discharge method thereof

(75) Inventors: Maho Shoji, Tokyo (JP); Noriyuki Kubota, Tokyo (JP)

Correspondence Address: SUGHRUE, MION, ZINN, MACPEAK & SEAS, 2100 Pennsylvania Avenue, N.W., Washington, DC, 20037, US

(73) Assignee: NEC CORPORATION

(21) Appl. No.: 09/973,821

(22) Filed: Oct. 11, 2001

(30) Foreign Application Priority Data
Oct. 12, 2000 (JP) 311462/2000

(51) Int. Cl. B23K 31/02; B23K 37/00

(52) U.S. Cl. 228/180.5; 228/4.5

(57) ABSTRACT

A wire bonding apparatus of the present invention comprises a torch rod 1 for providing a discharge voltage, a capillary 3 vertically displaceable within a predetermined range and inserting a bonding wire 7 therein, and means 9, 8 for synchronously and vertically displacing the torch rod 1 as the capillary 3 is moved to an upper portion of the predetermined range in which the position at the time of discharge is included.

### BACKGROUND OF THE INVENTION

1. Field of the Invention

The present invention relates to a wire bonding apparatus and a discharge method in a wire bonding apparatus for manufacturing a semiconductor device.

2. Description of Related Arts

A conventional wire bonding apparatus includes a torch rod 1 and a capillary 3, as can be seen by referring to the perspective views in FIGS. 1 and 2. The torch rod 1 is securely attached to a bonding head 5, which is provided on a stage 6. The capillary 3 is securely attached to a bonding tool 2, which is coupled with a rotary arm 4. Since the rotary arm 4 is supported by the bonding head 5 so that it can be rotated around its horizontal axis 4C, the capillary 3 can be displaced vertically within a predetermined range.

A bonding wire 7, such as a fine gold wire, is passed through, i.e., inserted into, the capillary 3 and the bonding tool 2 is moved upward using the rotary arm 4. When the distal end of the bonding wire 7 projecting downward from the capillary 3 reaches a position higher than that of the torch rod 1, movement of the capillary 3 is halted, and upon the discharge of a voltage between the torch rod 1 and the bonding wire 7, the distal end of the bonding wire 7 melts, forming a ball. Thereafter, the capillary 3 is moved downward until the ball is pressed against and deposited on a semiconductor chip (not shown), which is positioned below the torch rod 1, to perform a wire bonding process.

When the wire bonding of one semiconductor chip or of one wiring area has been completed, the bonding tool 2 is moved upward rapidly to begin the bonding of the next semiconductor chip or of the next wiring area. Thus, immediately after the bonding tool 2 has been halted, as is indicated by an imaginary line and a solid line in FIG. 2, residual vibration occurs, affecting the bonding tool 2 and the rotary arm 4. As a result, it is difficult to maintain a constant distance between the torch rod 1 and the distal end of the bonding wire 7, and stable ball formation is not possible.

Stable ball formation can be achieved by waiting for the residual vibration to stop completely before a discharge voltage is applied, but when this method is employed, the total time required for bonding is increased.

### SUMMARY OF THE INVENTION

To resolve these shortcomings, it is one object of the present invention to provide a wire bonding apparatus that ensures stable ball formation and that does not extend the total time required for bonding.

It is another object of the present invention is to provide a discharge method in a wire bonding process that ensures stable ball formation and that does not extend the total time required for bonding.

To achieve the above objective, the following configuration is employed for the present invention.

According to one aspect of the invention, there is provided a wire bonding apparatus comprises a torch rod for supplying a discharge voltage, a capillary vertically displaceable within a predetermined range and inserting a bonding wire therein, and means for displacing the torch rod vertically and synchronously with the capillary when the capillary is moved to an upper range positioned upper level than that of the torch rod within the predetermined range. The upper range includes a discharging range where the discharge is conducted between the torch rod and distal end of the bonding wire.

The wire bonding apparatus may further comprises a bonding head and a bonding tool to which said capillary is attached. The means for displacing the torch rod may include a coupling unit for movably coupling the torch rod to the bonding head, and a contact unit with which the torch unit engages said bonding tool. In this feature, the wire bonding apparatus may further comprises a shock absorber for damping the shock accompanying the engagement of the torch rod with the bonding tool.

The coupling unit may be constituted of leaf springs. Or else, the coupling unit may be constituted of a link mechanism. Moreover, the coupling unit may be constituted of a guide mechanism.

The contact unit may be constituted of an arm shape that extends from the torch rod to a position above the bonding tool, and contacts said bonding tool. Alternatively, the contact unit may be constituted of an arm shape that extends from the bonding tool to the lower portion of the torch rod, and contacts the torch rod.

The wire bonding apparatus may further comprise a stopper for restricting the downward displacement of the torch rod to a distance equal to or greater than a predetermined distance.

According to another aspect of the invention, there is provided a discharge method in a wire bonding apparatus; the wire boning apparatus comprises a torch rod used for a discharge voltage, and a capillary, which is moved vertically within a predetermined range and into which a bonding wire is to be inserted; the discharge method for discharging a voltage between the torch rod and the bonding wire comprises the steps of vertically displacing the torch rod, synchronized with the movement of said capillary, within an upper range positioned upper level than that of the torch rod in the predetermined range; and discharging the voltage when the capillary is moved upward into the upper range.

### BRIEF DESCRIPTION OF THE DRAWINGS

FIG. 1 is a perspective view of a conventional wire bonding apparatus;

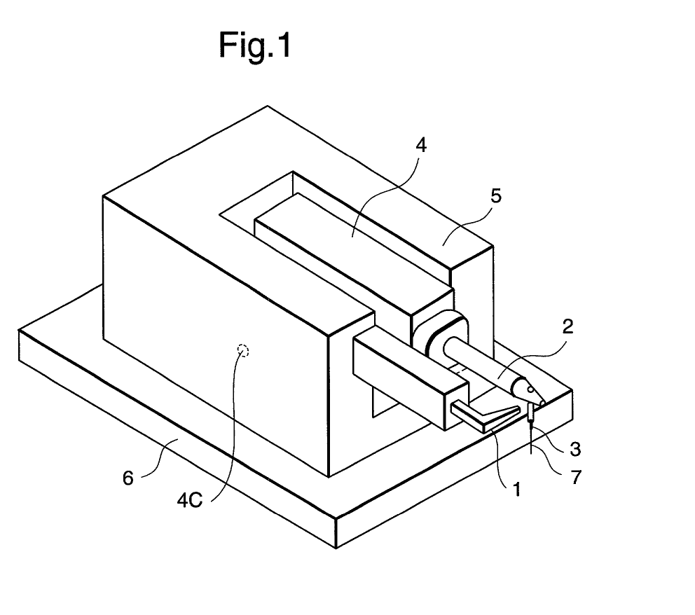

FIG. 2 is a perspective view of the action of the wire bonding apparatus in FIG. 1;

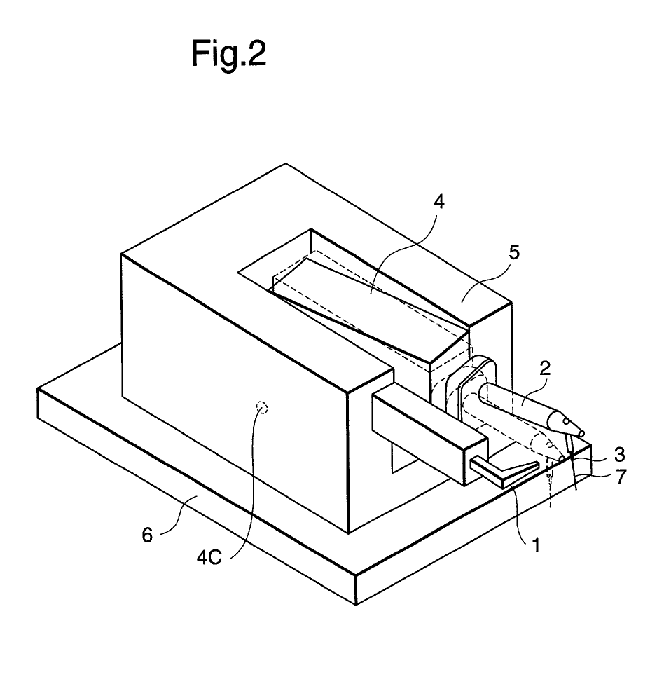

FIG. 3 is a side view of a wire bonding apparatus according to one embodiment of the present invention;

FIGS. 4A to 4C are front views of the action of the wire bonding apparatus in FIG. 3, in which FIG. 4A shows a position of after bonding is completed; FIG. 4B shows a position of spark (discharge) start; and FIG. 4C shows a position of spark (discharge); and

FIG. 5 is a side view of a wire bonding apparatus according to another embodiment of the present invention.

### DETAILED DESCRIPTION OF THE PREFERRED EMBODIMENTS

The preferred embodiments of the present invention will now be described in detail.

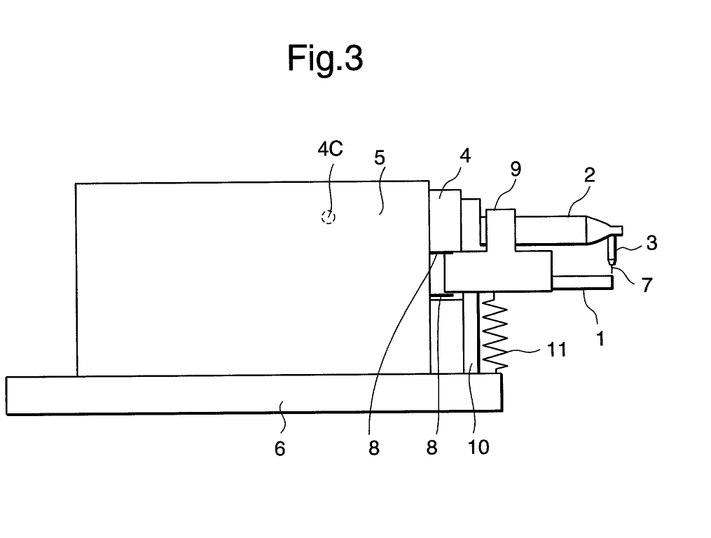

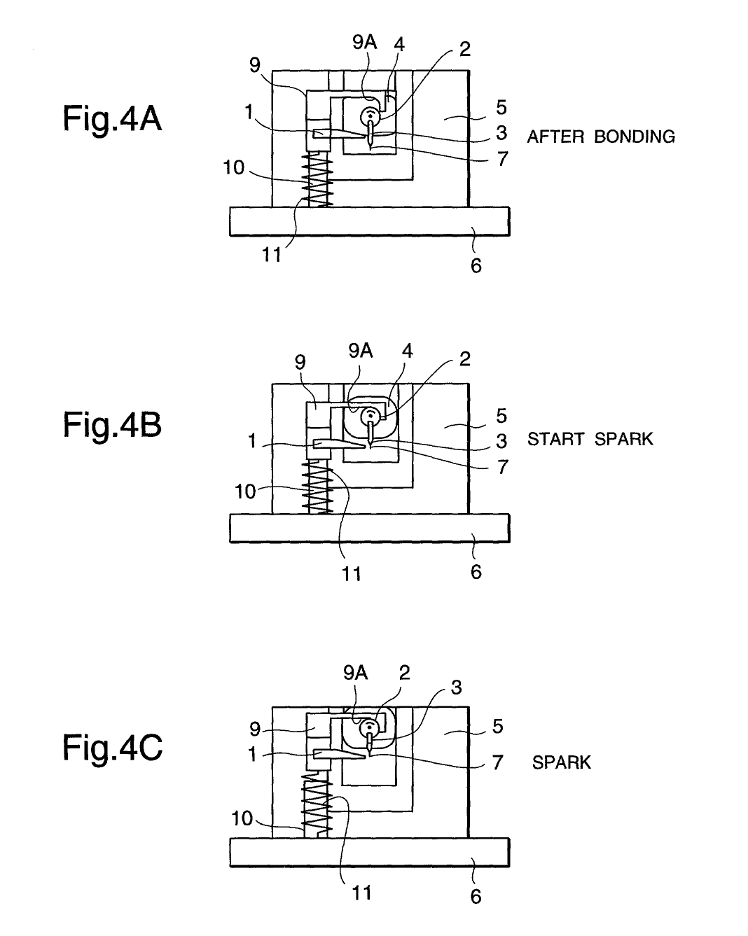

As is shown in the side view in FIG. 3 and the front view in FIGS. 4A to 4C, a wire bonding apparatus according to one embodiment comprises: a torch rod 1 used for a discharge voltage, and a capillary 3, which is moved vertically within a predetermined range and into which a bonding wire 7, such as a fine gold wire, is to be inserted.

The torch rod 1 is attached via a coupling unit 8 to a bonding head 5 mounted on a stage 6. In this embodiment, the coupling unit 8 is a pair of leaf springs that are positioned vertically at an interval to each other, as if the broader section of the torch rod is located therebetween. With this arrangement, the torch rod 1 can be displaced vertically within the range provided by the deflection of the leaf springs.

The torch rod 1 includes a contact unit 9. In this embodiment, the contact unit 9 is an arm shape that is raised at the broader middle portion of the torch rod 1, is extended horizontally above the bonding tool 2, and is bent downward at its distal end.

The capillary 3 is securely attached to the bonding tool 2, which is coupled with a rotary arm 4. The rotary arm 4 is rotatably supported at its horizontal axis 4C by a bonding head 5. With this arrangement, the capillary 3 can be moved vertically within a predetermined range.

After wire bonding at one wiring area has been performed, the arm 9, which is the contact unit of the torch rod 1, is positioned above and at a distance from the bonding tool 2, as is shown in FIG. 4A. The size of the arm 9 is so determined that when the capillary 3 is moved to the spark (discharge) start position by the bonding tool 2, the arm 9 contacts the bonding tool 2 at the inner upper surface 9A, as is shown in FIG. 4B. The spark (discharge) start position is that whereat the movement of the bonding tool 2 of the conventional wire bonding apparatus is halted while the capillary 3 is positioned to receive the discharge.

In the wire bonding apparatus in FIGS. 3 and 4A to 4C, the torch rod 1 is coupled with the bonding head 5 via the leaf springs 8, and therefore can be displaced against the bonding head 5. Consequently, when the bonding tool 2 is moved upward a specific distance, to the spark start position, it engages the arm 9 of the torch rod 1, the bonding tool 2 and the torch rod 1 are synchronously displaced further upward.

The wire bonding apparatus shown in FIGS. 3 and 4A to 4C can be operated as follows.

When wire bonding is terminated at one wiring area and the bonding tool 2 is moved upward to the spark (discharge) start position, in the conventional discharge method, the movement of the bonding tool 2 is halted and a discharge voltage applied between the torch rod 1 and the bonding wire 7, so that the distal end of the bonding wire 7 is melted and forms a ball.

In this embodiment, however, in the period during which the torch rod 1 is synchronously displaced upward with the bonding tool 2, a substantially constant distance is maintained between the torch rod 1 and the distal end of the bonding wire 7 that projects downward from the capillary 3. Thus, a discharge voltage can be applied during the upward displacement of the torch rod 1; that is, the upward movement need not be halted for the discharge to take place. As a result, while a ball can be stably formed, both the discharge time and the total time required for the wire bonding can be reduced.

According to the discharge method used for the wire bonding apparatus of the present invention, the torch rod 1, in synchronization with the movement of the capillary 3, is displaced upward and downward into the upper portion of the predetermined range established for the capillary 3, to the position whereat the discharge occurs, and the discharge occurs as the capillary 3 moves upwardly into the upper portion of the range. With this method, the above described action and effects can be correctly obtained, and as is shown in FIG. 4C, at the time the discharge takes place, the range within which that can occur extends from the spark start position to the upper limit position attained by the capillary 3. Within this range, the spark, i.e., the discharge, can be released at an arbitrary time.

The coupling unit 8 and the contact unit 9 constitute means for vertically displacing the torch rod 1, synchronized with the movement of the capillary 3, into the upper limits of the predetermined range to the position whereat the discharge occurs.

In this embodiment, the wire bonding apparatus includes a shock absorber member 11 for damping the shock produced when the torch rod 1 is engaged by the bonding tool 2. The shock absorber member 11 is a tension spring that extends from the stage 6 to the middle portion of the torch rod 1. When the bonding tool 2 moves upward at high speed and engages the upper inner surface 9A of the arm 9, the torch rod 1 tends to spring upward from the shock of the sudden contact, but at this time the tension spring, the shock absorber member 11, is extended and damps the shock, so that a residual vibration to which the torch rod 1 is frequently subjected is suppressed. In general, since the torch rod 1 is lighter than the bonding tool 2, and since the shock produced by the engagement of the torch rod 1 and the bonding tool 2 causes the torch rod 1 to vibrate, the shock absorber member 11 is correlatively positioned with the torch rod 1.

In this embodiment, the wire bonding apparatus also includes a stopper 10 for inhibiting the downward displacement of the torch rod 1 and preventing it from proceeding further than a predetermined distance. The stopper 10 is a member extended upright from the stage 6, and its height is so set that the torch rod 1 is disposed on the stage 6 as is shown in in FIG. 4B when the bonding tool 2 has moved downward from its upper limit position to the spark start position. With this arrangement, the downward displacement of the torch rod 1 is synchronized with the movement of the bonding tool 2 as the bonding tool 2 moves downward from its upper limit position to the spark start position, but there, while the downward movement of the bonding tool 2 continues, the torch rod 1 is halted and held by the stopper 10, permitting the bonding tool 2 to independently move down to the bonding position.

Since the present invention can be carried out in a variety of ways, another embodiment will now be described.

In the above embodiment, the coupling unit 8 is composed of a pair of leaf springs, and since the torch rod 1 is moved substantially parallel to the bonding tool 2 by the pair of leaf springs, a substantially constant distance can be easily maintained between the torch rod 1 and the distal end of the bonding wire 7 projecting downward from the capillary 3. The coupling unit 8 can easily be constituted merely of fixing a pair of leaf springs to the bonding head 5 and the torch rod 1.

Instead of a pair of leaf springs, however, a parallel linking mechanism or a parallelopiped linking mechanism may be employed to provide obtain substantially the same parallel movement as that provided by the leaf springs. Therefore, this linking mechanism can also be used to constitute the coupling unit 8.

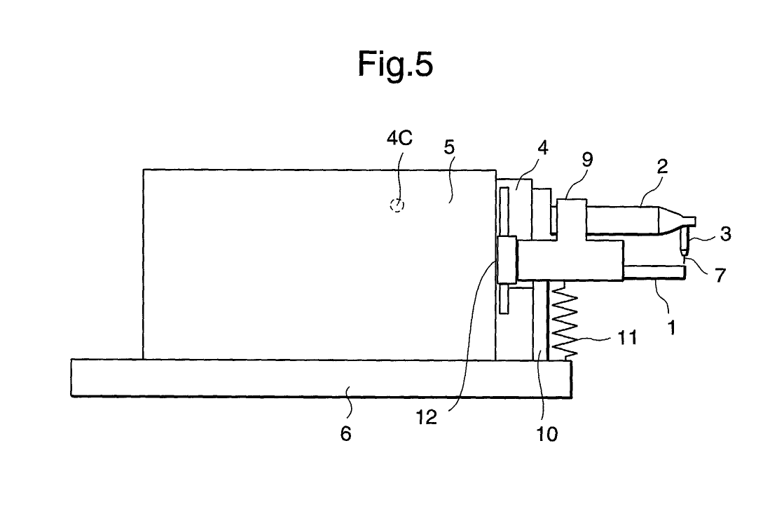

FIG. 5 is a side view of a wire bonding apparatus according to another embodiment. For this wire bonding apparatus, a coupling unit 12 is located between a torch rod 1 and a bonding head 5. The coupling unit 12 in this embodiment is a guiding mechanism wherein a guide rail is provided on the bonding head 5 and guide member sliding along the guide rail is provided in the torch rod 1. Further, this guiding mechanism may be constituted of attaching a pair of leaf springs to the guide members and attaching the torch rod 1 to the leaf springs. With this guiding mechanism, the torch rod 1 is displaced vertically.

In this embodiment, a contact unit 9 is an arm shape that extends outward from the torch rod 1 above a bonding tool 2, to which a capillary 3 is attached, that it contacts. Instead of this arm, however, the contact unit 9 may be an arm that extends downward from the bonding tool 2 and below the torch rod 1, which it contacts. In the former case, the arm shape supports the torch rod 1 from above, while in the latter case the arm supports the torch rod 1 from below.

In this embodiment, a shock absorber member 11 is a tension spring; however, as the shock absorber member 11, a compression spring or an urethane member may be attached to a plate that extends outward from the bonding head 5 above the coupling unit 9.

The number of components and their positions and shapes are not limited to those in the embodiments, and an arbitrary number of components and arbitrary positions and shapes for them can be employed to carry out the invention.

The same reference numerals are used throughout the embodiments to denote corresponding or identical components.

With the above-described arrangements of the embodiments, the following advantages can be obtained.

The wire bonder of the invention includes means for vertically displacing the torch rod, in synchronization with the movement of the capillary, as the capillary is moved into the upper portion, wherein the discharge position or range is located, of a predetermined range within which it can be moved. Therefore, a substantially constant distance can be maintained between the torch rod and the distal end of the bonding wire that projects downward from the capillary and the formation of a ball can be stably performed.

According to the discharge method for a wire bonding apparatus of the present invention, since the discharge is performed while the torch rod is displaced upward in synchronization with the movement of the capillary, the movement of the capillary need not be halted for the discharge to be performed. Thus, the discharge time and the total bonding time can be reduced. Furthermore, since the capillary and the torch rod are synchronously moved, and since a substantially constant distance is maintained between the torch rod and the distal end of the bonding wire that projects downward from the capillary, the formation of a ball can be stably performed.

What is claimed is:

1. A wire bonding apparatus comprising:
a torch rod for supplying a discharge voltage;
a capillary vertically displaceable within a predetermined range and inserting a bonding wire therein; and
means for displacing said torch rod vertically and synchronously with said capillary when said capillary is moved to an upper range within said predetermined range; said upper range include a position where the discharge is conducted between said torch rod and the distal end of said of said bonding wire.

2. A wire bonding apparatus according to claim 1, further comprising:
a bonding head; and
a bonding tool, to which said capillary is attached,
wherein said means for displacing said torch rod includes a coupling unit for movably coupling said torch rod to said bonding head, and a contact unit with which said torch unit engages said bonding tool.

3. A wire bonding apparatus according to claim 2, further comprising:
a shock absorber for damping the shock accompanying the engagement of said torch rod with said bonding tool.

4. A wire bonding apparatus according to claim 2, wherein said coupling unit includes leaf springs.

5. A wire bonding apparatus according to claim 2, wherein said coupling unit includes a link mechanism.

6. A wire bonding apparatus according to claim 2, wherein said coupling unit includes a guide mechanism.

7. A wire bonding apparatus according to one of claims 4 to 6, wherein said contact unit includes by an arm that extends from said torch rod to a position above said bonding tool, and contacts said bonding tool.

8. A wire bonding apparatus according to one of claims 4 to 6, wherein said contact unit includes an arm that extends from said bonding tool to the lower portion of said torch rod, and contacts said torch rod.

9. A wire bonding apparatus according to claim 1, further comprising:
a stopper, for restricting the downward displacement of said torch rod to a distance equal to or greater than a predetermined distance.

10. A discharge method in a wire bonding apparatus; said wire boning apparatus comprises a torch rod used for a discharge voltage, and a capillary, which is moved vertically within a predetermined range and into which a bonding wire is to be inserted; said discharge method for discharging a voltage between said torch rod and said bonding wire, comprising the steps of:
vertically displacing said torch rod, synchronized with the movement of said capillary, within an upper range in said predetermined range; and
discharging between said torch and said bonding wire when said capillary is moved upward into said upper range.
